(19) United States
(12) Patent Application Publication
(10) Pub. No.: US 2007/0255792 A1
(43) Pub. Date: Nov. 1, 2007

(54) Method and apparatus for an email gateway

(75) Inventor: Roger Gronberg, Bunkeflostrand (SE)

Correspondence Address: IP CREATORS, P. O. BOX 2789, CUPERTINO, CA, 95015, US

(73) Assignee: MOMAIL, AB, Limhamn (SE)

(21) Appl. No.: 11/656,740

(22) Filed: Jan. 23, 2007

Related U.S. Application Data
(60) Provisional application No. 60/794,690, filed on Apr. 26, 2006.

(51) Int. Cl. G06F 15/16

(52) U.S. Cl. 709/206

(57) ABSTRACT

An email gateway capable of managing the email experience of users operating on disparate communication devices and networks. The gateway allows configuration of emails on the basis of the hardware and software capabilities of the receiving, a.k.a. targeted communication device. The email gateway includes: a splitter, a database, a device detector and a target optimizer. The splitter splits received emails into discrete body and attachment portions. The database is coupled to the splitter and configured to store the discrete body and attachment portions of each email received from the splitter. The device detector detects the hardware and software capabilities for a corresponding communication device prior of delivery of email to same. The target optimizer is coupled to the database and the device detector and responsive to an email request to optimize the body and attachment portions of associated emails for delivery to the communication device based on the capabilities of the communication device as detected by the device detector.

### CROSS REFERENCE TO RELATED APPLICATION

This application claims the benefit of prior filed co-pending Provisional Application No. 60/794,690 filed on Apr. 26, 2006 entitled “Method for Altering Data” (Atty. Docket # MOMAP010P) which is incorporated herein by reference in its entirety as if fully set forth herein.

### BACKGROUND OF THE INVENTION

1. Field of Invention

The present invention is generally related to network communication systems, and more particularly to device specific optimization of email communications over a network.

2. Description of the Related Art

There is increasing consumer pressure to erase traditional distinctions between mobile phones, personal digital assistants (PDA), notebook computers, and desktop workstations. The advent of Voice over Internet Protocol (VOIP) and free and fee based services for delivering same is changing the perceptions of desktop computers. The advent of Windows Mobile and other operating mobile operating systems promises an extension of the desktop experience to mobile devices. Currently the most ubiquitous example of the increasing integration of wired and wireless networks of cellular and computer networks is provided by emails which are expected to pass seamlessly between disparate devices on either wired or wireless networks.

From a technical perspective the task of handling email on mobile and desktop communication devices is challenging. Cellular and desktop communication devices differ from one another in terms of: display sizes, processing power, network and processing bandwidth and resident software applications. The total pixel count varies by almost two orders of magnitude between a typical cell phones pixel count of 176×220=38,720 pixels to the 1920×1200=2,304,000 pixel count for the large flat panel display for a desktop computer. Processing power also varies by several orders of magnitude between a typical cell phone with a single core processor clocked at 300 Mega Hertz vs. a workstation which may have a dual or quad core processor clocked at 3.8 Giga Hertz. Volatile memory, a.k.a. random access memory (‘RAM’) in a typical cell phone is 64 Megabytes whereas a desktop computer will have 1-4 Gigabytes. File storage on a cell phone is accomplished using resident RAM whereas on a computer file storage is accomplished with 40-80 gigabyte hard drive. Cellular networks have data transfer rates of 300-700 Kilobits per second vs. a typical corporate intranet at 10-100 Megabits per second.

Email communications range in complexity from a simple text message to an HTML document with embedded images and related attachments. Frequently email, as opposed to file transfer protocol (‘FTP’), serves as the preferred method of file sharing and document transport within and between organizations large and small. These files and documents although referred to as email attachments are in fact part of the email itself and their bundling and unbundling at opposite ends of the communication process consumes considerable processing horsepower and time. After an email attachment is received it must be opened by a compatible resident application for viewing or editing by the recipient. If there is no corresponding application, e.g. word processing, spreadsheet, graphics, then attempts to open the attachment will prove fruitless thereby thwarting the communication process.

What is needed is a unified communications approach for handling communications between a broad range of communications devices, mobile and fixed, wireless and wired.

### SUMMARY OF THE INVENTION

A method and apparatus is disclosed for an email gateway capable of managing the email experience of users operating on disparate devices and networks. The gateway allows configuration of emails on the basis of the hardware and software capabilities of the receiving, a.k.a. targeted device. Incoming emails are split into body and attachment portions and stored in the gateway. Outgoing emails are passed though various assembly stages each of which is specific to the requesting, a.k.a. targeted device. The integrated storage and retrieval capabilities allow the gateway to regenerate emails forwarded from a cell phone to a desktop computer, thus preserving the integrity of the original communication. Stored Email attachments are separately accessible either directly via a web based user interface or via links embedded into the body portion of outgoing emails. In either case attachment pass through various assembly stages each of which is specifically configures the attachment to the capabilities of the requesting device.

In an embodiment of the invention an email gateway configured to couple to at least one network of communication devices is disclosed. The email gateway includes: a splitter, a database, a device detector and a target optimizer. The splitter splits received emails into discrete body and attachment portions. The database is coupled to the splitter and configured to store the discrete body and attachment portions of each email received from the splitter. The device detector detects the hardware and software capabilities for a corresponding communication device prior of delivery of email to same. The target optimizer is coupled to the database and the device detector and responsive to an email request to optimize the body and attachment portions of associated emails for delivery to the communication device based on the capabilities of the communication device as detected by the device detector.

### BRIEF DESCRIPTION OF THE DRAWINGS

These and other features and advantages of the present invention will become more apparent to those skilled in the art from the following detailed description in conjunction with the appended drawings in which:

FIG. 1 shows a plurality of wired and wireless communication devices with email clients displaying a common email;

FIG. 2 shows selected ones of the communication devices of FIG. 1 coupled to one another for email exchange via an email gateway;

FIG. 3A shows a graphical user interface (GUI) embodiment for entering member preferences into the email gateway shown in FIG. 2;

FIG. 3B shows an alternate embodiment of the GUI for entering member preferences into the email gateway shown in FIG. 2;

FIG. 4 shows a GUI for management of email attachments in accordance with an embodiment of the invention.

FIGS. 5A-5B show header, text, body and attachment portions of an email before and after optimization for a specific target communication device;

FIG. 6 shows an XML formatted hardware and software specification for a selected mobile device;

FIG. 7 shows a data structure for discretely managing email header body portions and attachment portions in accordance with an embodiment of the invention;

FIG. 8 shows a combined hardware and software block diagram of an embodiment of the email gateway shown in FIG. 2;

FIG. 9 shows a hardware block diagram of an embodiment of the email gateway shown in FIG. 2;

FIGS. 10A-10B show process flow diagrams for email receipt and delivery in the email gateway of FIG. 2, in accordance with an embodiment of the invention;

FIG. 11 is a process flow diagram of processes associated with managing discrete attachment requests or queries in the email gateway of FIG. 2, in accordance with an embodiment of the invention.

### DETAILED DESCRIPTION OF THE EMBODIMENTS

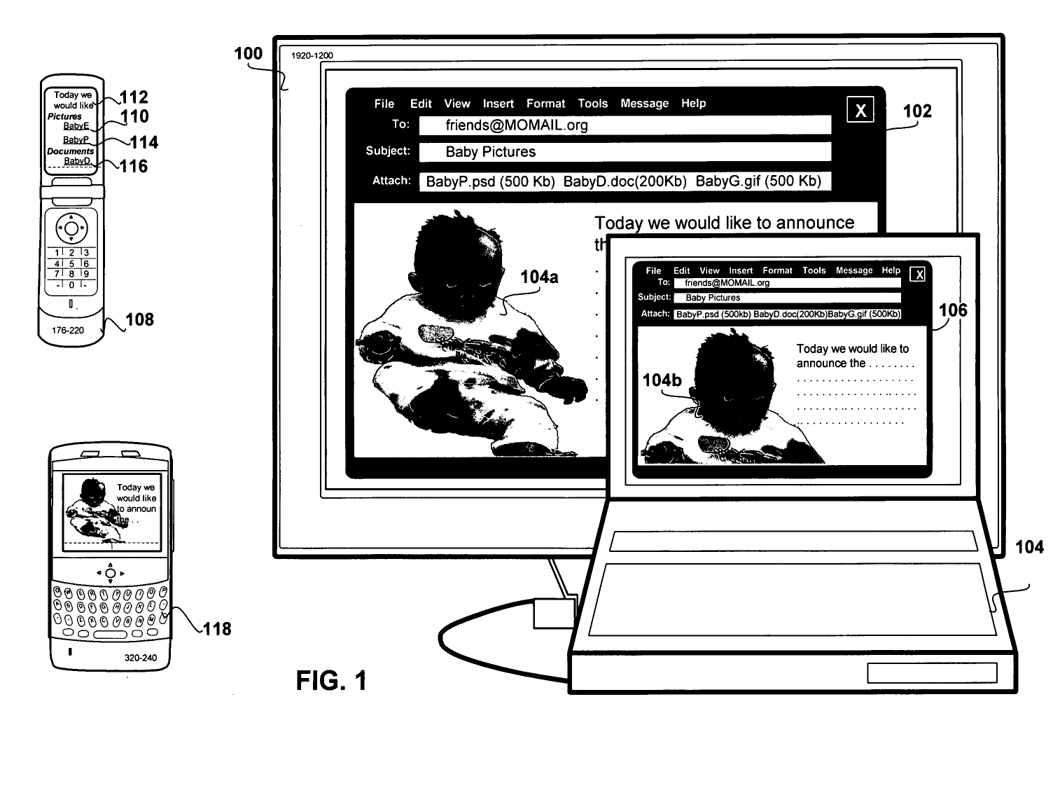

FIG. 1 shows a plurality of wired and wireless communication devices with email clients displaying a common email. Several cell phones 108, 118, a notebook computer 104 and a computer workstation display 100 are shown. These communication devices differ from one another in terms of: display sizes, processing power, network and processing bandwidth and resident software applications. The most visible of these differences are the display sizes of each. The cell phones 108, 118 have 176×220 and 320×240 pixel displays respectively. The notebook computer 104 has a 1024×768 pixel display and the flat panel monitor 100 has a 1920×1200 pixel display. Thus the total pixel count varies by 70/1 or almost two orders of magnitude between the smallest cell phones pixel count of 176×220=38,720 pixels to the 1920×1200=2,304,000 pixel count for the large flat panel monitor. Processing power, volatile memory, file storage and network bandwidth capabilities exhibit similar variations.

The email gateway of the current invention manages email communications between these disparate communication devices in a manner which takes into account the hardware software capabilities and user preferences for each target communication device. Email communications range in complexity from a simple text message to an HTML document with embedded images and related attachments. These files and documents although referred to as email attachments are in fact part of the email itself The email gateway of the current invention manages attachments based on target or receiving email device capabilities and user preferences. Attachments may on a device specific basis be excluded from the email, or referenced in the email via a text hyperlink, or included in the email. When an attachment is delivered to a requesting device, the email gateway may subject the attachment to device specific conversion from its original file type to a file type compatible with software applications on the receiving communication device.

In FIG. 1 all communication devices are shown with an initial display via an associated email client application of a common email delivered to each communication device on a device specific basis, i.e. configured on the basis of the hardware and software specifications of the target device in combination with any user preferences associated therewith. The original format 102 of this common email is shown on display 100. Email 102 contains HTML formatted body with an embedded image 104a and with three attachments of different file types identified as: ‘BabyP.psd’, ‘BabyD.doc’ and ‘BabyG.gif’. Each attachment is associated with a different software application. The .psd file type is a proprietary bitmap format associated with image processing application ‘Photoshop’ by Adobe Systems Inc. of San Jose Calif. The .doc file type is a proprietary word processing format associated with the ‘WORD’ application by Microsoft Corporation of Redmond Wash. The .gif file type is a bitmap format that is widely supported by image processing applications, web browsers and email clients. The same email 106 with embedded image 104b and related attachments is shown in the email client of notebook computer 104 as well.

The email gateway of the current invention delivers the email to the mobile communication devices 108 and 118 in different formats due to the reduced display sizes, processing ability, and limited set of software applications on these cell phones. In the case of cell phone 118 the embedded image 104c and attached image files (not shown) are resized for the target devices display, i.e. 320×240 pixels and may also be converted from .psd and .gif formats to a widely supported image format such as Joint Photographic Experts Group (‘.jpg’). Resizing proportionately reduces image size without affecting image quality. Resizing reduces both data transfer bandwidth and processing requirements on the receiving device since the image is already scaled for the receiving device. Format conversion particularly in the case of non-supported application types such as .psd allows a file to be viewed on a receiving device by a supported application file type, e.g. .jpg. Additionally since the .jpg format is a lossy format further reduction in data transfer bandwidth can be achieved through compression, albeit at a loss of image quality.

The email that is delivered to mobile communication device 108 is initially delivered without either attachments or embedded images. This is due both to the reduced display size, the lack of required software applications and user preferences established for the target device. The baby image 104a embedded in the email 102 has been replaced with an image hyperlink in the body of the email. Selection of this link results in device specific processing of the original stored image at the gateway for subsequent delivery to the cell phone. This processing may include: resizing for the target display, image rotation if appropriate and file type conversion as required to enable viewing of the image by a resident software application on the cell phone. The text portion 112 of the original email is transferred to the cell phone. In the embodiment shown the email gateway determines the user preferences and/or default hardware and software specifications for the target communication device 108 and manages the attachments accordingly. In the example shown, the attachments to the original email are not delivered in the initial communication, rather text links to same are delivered to the cell phone with the text links 110, 114, 116 sorted by attachment type and labeled accordingly, e.g. ‘Pictures’ or ‘Documents’. The recipient is able to access the attachments by selecting these hyperlinks 110, 114, 116 embedded in the body of the email. Selection of a hyperlink results in device specific processing of the attachments as stored at the gateway for subsequent delivery to the cell phone. This processing may include: resizing for the target display, image rotation if appropriate and file type conversion as required to enable viewing of the image by a resident software application on the cell phone.

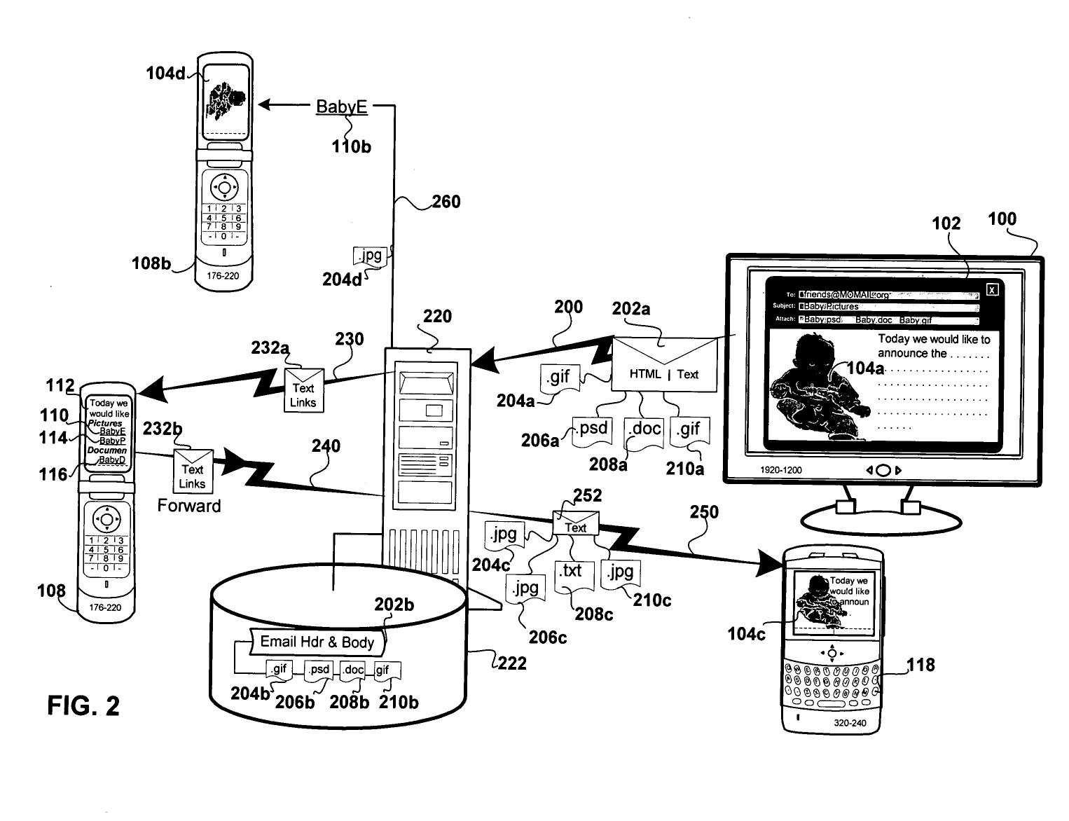

FIG. 2 shows selected ones of the communication devices 100, 108, 118 of FIG. 1 coupled to one another for email exchange via the email gateway 210. The email gateway includes storage 212 which in addition to related program code, user interfaces, device specifications and member profiles includes: storage for email header and body portions and attachment portions. In the example shown an email 102 is sent from the workstation (not shown) coupled to display 100 to a recipient whose associated communication devices includes cell phone 108. For the sake of this example the recipient has an account on the email gateway 210. This allows the gateway to process the email delivered to them taking into account not only the hardware and software capabilities of their target device(s) but also their device specific email preferences. From cell phone 108 the email is forwarded to another recipient where it is viewed on one of their communication devices 118.

The email 102 is sent 200 in a format which complies with RFC 822 Standard for the format of ARPA Internet Text Messages and Multi Purpose Internet Mail Extensions (‘MIME’) thereto. That format includes a single file with header and HTML and Text body portions 202a and an attachment portion with both inline and non-inline attachments 204a, 206a, 208a, 210a. Upon receipt by gateway 220 the email is split into discrete portions for storage in memory 222. The email header and body 202b are stored separately from the inline and non-inline attachments: 204b, 206b, 208b and 210b. When an email delivery request 230 is received by the email gateway the email gateway determines what to deliver and in what format to deliver the requested emails based on the hardware and software specifications of the requesting communication device and any applicable delivery preferences therefore. The extremely small display size of cell phone 108 coupled with limited number of resident software applications results in the delivery of the email 232a as text only with embedded document/file hyperlinks. Thus no attachments inline or otherwise are initially delivered to the device 108 by the email gateway. The baby image 104a embedded in the email 102 has been replaced with an image hyperlink 110 in the body of the email. Selection of this link results in device specific processing of the original stored image at the gateway for subsequent delivery to the cell phone. The text portion 112 of the original email is transferred to the cell phone. The non-inline attachments to the original email are also not delivered in the initial communication. The recipient is however able to access the attachments via hyperlinks 110, 114, 116 embedded in the body of the email a selection of which results in device specific processing of the attachments as stored at the gateway for subsequent delivery to the cell phone.

Communication device 108b shows communication device 108 after selection of image hyperlink 110. The URL 110b associated therewith is sent over an HTTP connection to the email gateway 220. This initiates a communication 260 which results in the processing of stored embedded image 204b on a target specific basis. In this case the email gateway resizes, rotates, and converts the file type of the stored image. Additionally depending on the resultant file size the image may be subject to an additional compression step before delivery as a .jpg image file 204d to the cell phone. The delivered image file in .jpg format is shown displayed on the cell phones browser client as image 104d.

The next step in the representative email exchange shown in FIG. 2 is the forwarding 240 of the email 232b to the intended recipient whose associated communication device is cell phone 118. The email gateway correlates the forwarded email 232b including the embedded hyperlinks with the original inline and non-inline attachments 204b, 206b, 208b and 210b stored in the database. When an email request 250 is received from communication device 118 by the email gateway 220 the target specific conversion of these stored attachments is affected. The inline baby picture 204b is restored after resizing and file type conversion steps and is added back to the email as inline attachment 204c. The Photoshop .psd file 206b including both text and graphics portions is restored after conversion to a .jpg format attachment 206c. The Word .doc file 208b is restored after conversion to a .txt formatted attachment 208c. The attached .gif image file 210b is restored after resizing and conversion to a .jpg formatted file type attachment 210c. Communication device is shown displaying the inline image 104c and associated text of the forwarded email. The ability of the email gateway to restore a forwarded email may also be utilized for email communications to recipients who do not have email accounts on the email gateway 220. For these recipients the email that is forwarded to their email server may be restored with 100% fidelity to its original file types and image sizes, by use of the stored attachments 204b, 206b, 208b 210b.

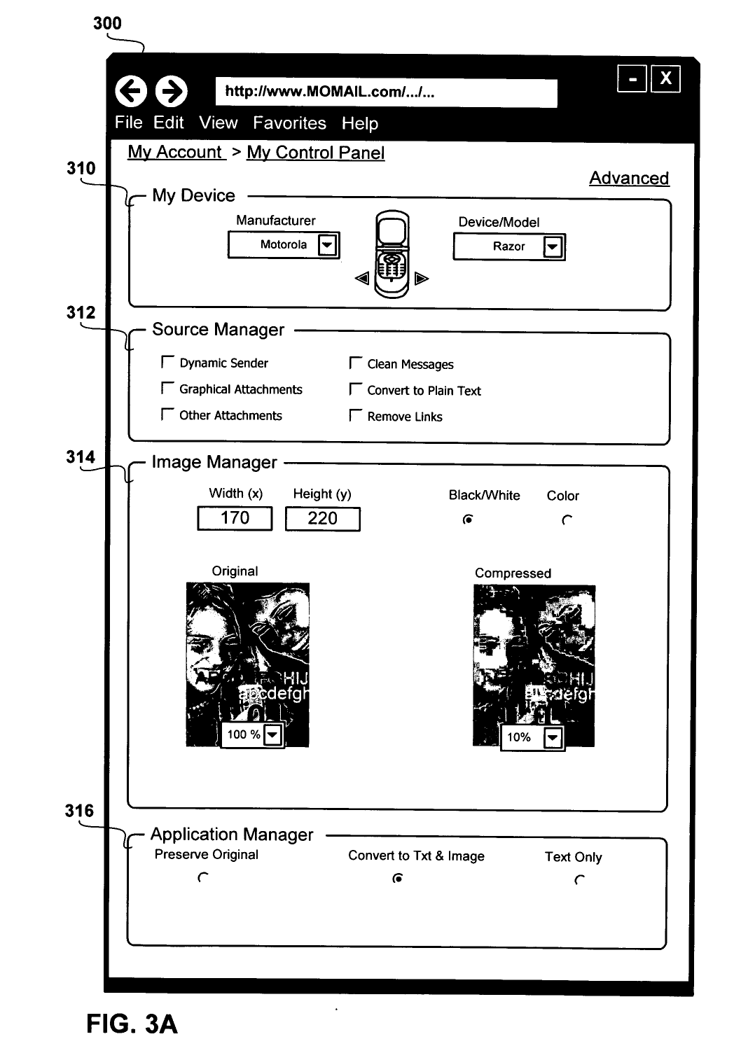

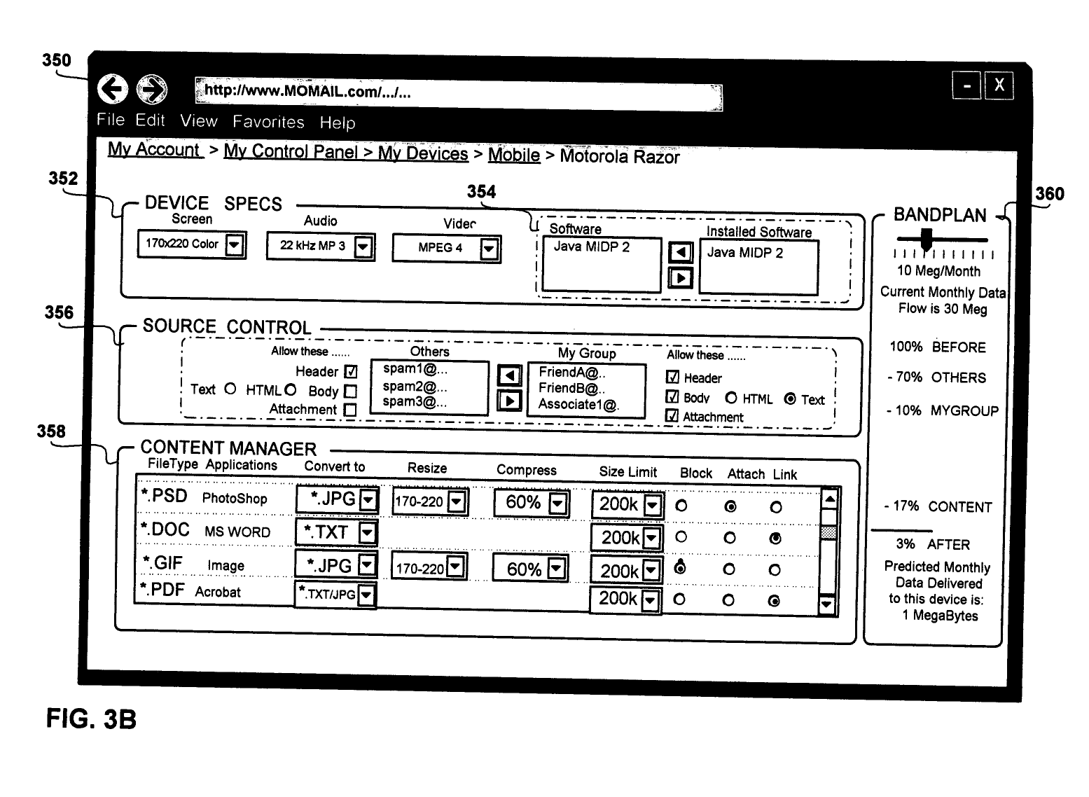

FIG. 3A shows a graphical user interface (GUI) 300 embodiment for entering member preferences into the email gateway shown in FIG. 2. The user interface includes a target device selection section 310, a source management section 312, an image management section 314 and an application management section 316.

In the target device selection section the member inputs the manufacturer and model number of their communication device. The associated hardware and software specifications of which are then associated with this member's record.

In the source management section the user has checkbox options for their email receipt preferences. The dynamic sender option enables the gateway to programmatically alter the email source/sender address to coincide with the address of the original recipient, e.g. me@hotmail.com as opposed to the forward address of me@momail.com. This allows for transparent consolidation of email accounts on a single gateway. The graphical attachment option enables the gateway to deliver outgoing emails with graphical attachments. If this option is not checked the gateway will deliver outgoing emails with hyperlinks to the graphical attachments on the email gateway. The other attachment option enables the gateway to deliver outgoing emails with non-graphical attachments. If this option is not checked the gateway will deliver outgoing emails with hyperlinks to the non-graphical attachments on the email gateway. The clean message option allows the gateway to perform cleanup of the incoming messages. The convert to plain text option allows the gateway to extract the text from the HTML portion of incoming emails and to inject that text into the text portion of outgoing emails. The remove link option prevents the gateway from injecting links to attachments into outgoing emails.

In the image management section the member may set preferences for received images either inline or non-inline. These preferences include custom image sizing, color vs. black and white, and amount of compression.

In the applicant management section the user can choose to: a) preserve non-image file attachments in their original format, e.g. .psd or .doc; or b) to have them converted by the gateway to a format which displays text and images graphically, e.g. .jpg; or c) to convert them to a text only format, e.g. .txt.

FIG. 3B shows an alternate embodiment of the GUI 350 for entering member preferences into the email gateway shown in FIG. 2. This GUI includes a device specifications section 352, a source control section 356, a content management section 358 and a band plan section 360.

In the device specification section the user enters device specific hardware and software parameters for each of their communication devices.

In the source control section the user enters email configuration settings for receipt of email on the specific one of their communications devices specified in the device specification section. These settings provide for different treatment for emails sent by friends or associates vs. email sent by others. Received emails may be discretely configured to include or exclude discrete sections, e.g.: header, body text, body html, and attachment.

In the content management sections email attachments conversion mapping, resizing, compression, and size limits may be specified on the basis of file type. Each file type may also be subject to one of: inclusion as an attachment, inclusion only via a hyperlink or blocking.

In the band plan section a slider bar shows the user the estimated monthly data flow at the given settings using the prior months received emails as a baseline. Alternately, when the user moves the slider bar the source control and content management sections are programmatically altered to achieve the required data rate based again on the prior months received emails.

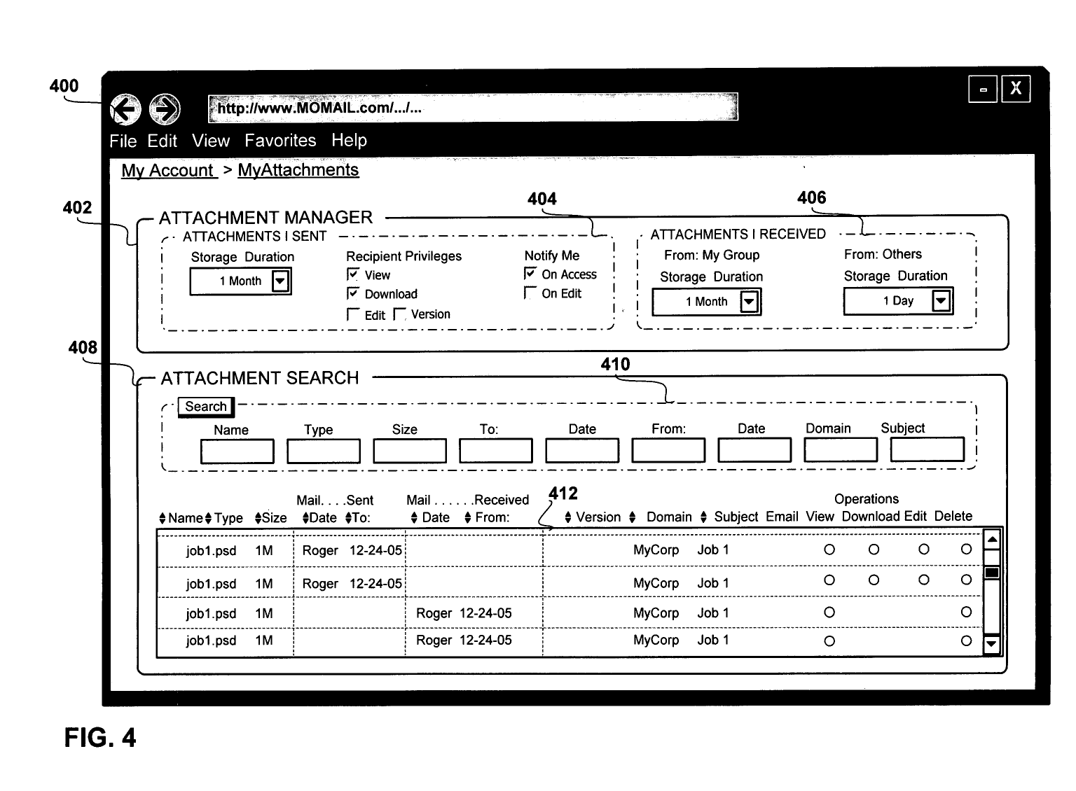

FIG. 4 shows a GUI 400 for management of email attachments in accordance with an embodiment of the invention. In an embodiment of the invention email attachments, inline and non-inline, are stored discretely from the original emails of which they are a part. Additionally, one or more web pages are provided by the email gateway which allow individual members to manage and accessing their email attachments. The GUI includes an attachment manager section 402 and an attachment search and view section 408.

The attachment manager section has two subsections 404, 406 in which a member can configure attachment policy for attachments sent and received respectively by the member. Policy for attachments sent by the member include: storage duration, recipient privileges and access notifications. The policy for attachments received by the member includes storage duration which varies based on the relationship between the sender and receiver.

The attachment search and view section includes in section 410 form inputs for building an attachment query by parameters including: file name, file type, file size, sender, recipient, and subject for example. The attachment list section 412 includes one row for each attachment satisfying the query with each row including a hyperlink to the corresponding email body portion associated with the attachment. Radio buttons on each row allow for attachment access consistent with the policies set by the associated sender or recipient.

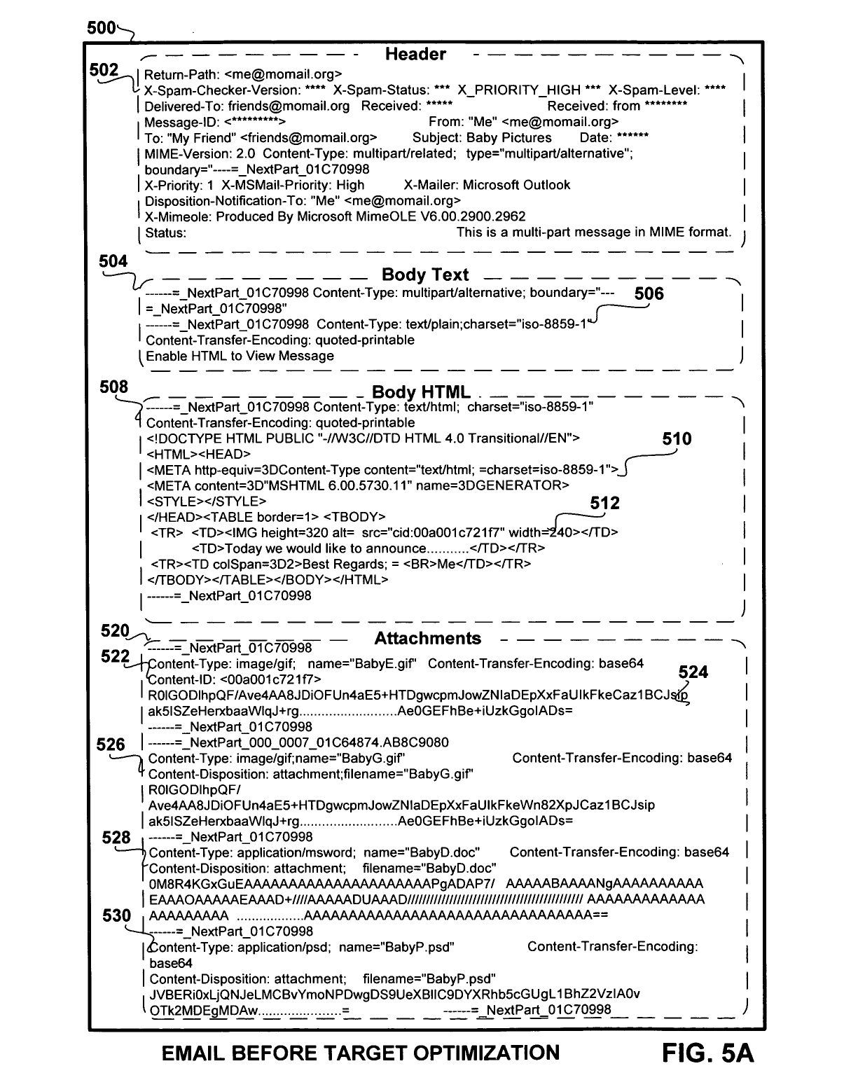

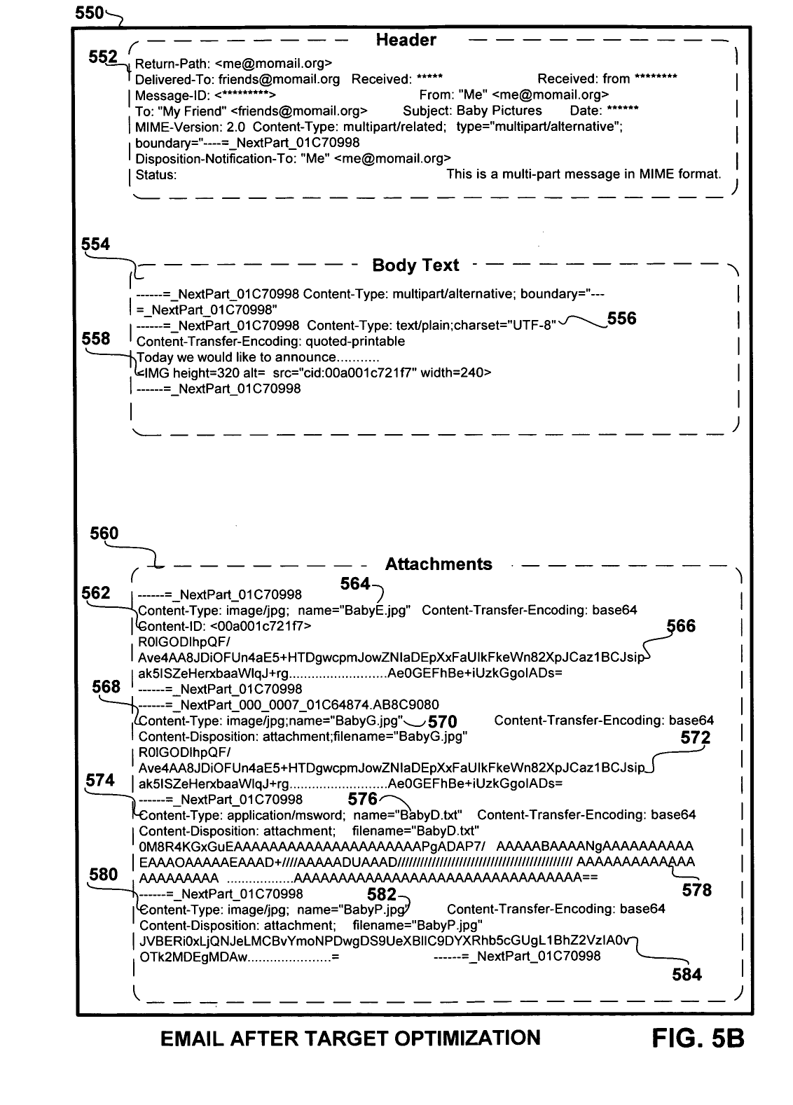

FIGS. 5A-5B show header, text, body and attachment portions of an email before and after optimization for a specific target communication device. The received email 500 comprises one email file of type e.g. .eml or .msg which includes inline and non-inline attachments which are base64 encoded. The received email includes a header 502, a body in text format 504, an alternate body in HTML format 508, and attachments 516. The header portion includes email meta data such as: To:, From:, CC:, BCC:, Subject:, Return Path, Mime Type along with custom fields associated with the application which generated the email or the Spam checking that was performed on the email.

The body-text section 504 is tag delimited with a ‘- - -=_Next Part: ‘tag and a content and character set identifier 506. The character set, i.e. iso-8859-n; is one of the standard 8 bit character encodings used on computers in North America and Western Europe, which attempts to cover the main characters used in the 14 plus dominant languages thereof within the 256 characters encoded thereby. The -n suffix currently covers 9 regional variations to expand coverage to Eastern European, Mediterranean, and African languages. Worldwide there are over 100 character sets used on various computers for encoding the electronic bits “1s and 0s” by which documents and communications are stored on and transferred between computers. These character sets range in complexity from 7-32 bits per character with the older character sets such as ‘iso-8859’ covering 256 or fewer characters and requiring fewer bits to encode a character and the newer International standards such as ‘Unicode-n’ which attempt to cover all the worlds languages in a single character set and require therefore more bits per character for encoding. Of these later standards Unicode Transformation Format-8 (‘UTF-8’) is the most prevalent. UTF-8 encodes each Unicode character as a variable number of 1 to 6 bytes.

The body-HTML section 508 is tag delimited with a Next Part tag and includes the email body in the form of an HTML document. This document includes a meta tag 510 which identifies content type and character set for the document, i.e. ‘text/html’ and iso-8859-1 respectively. Within a ‘<td>’ tag of the document the image tag for the baby picture 104a (See FIG. 1) is shown. The source property 512 of the image tag has a ‘CID’ pointer to one of the following attachments 522 which are also included in the email file.

The attachment section 520 of the email contains subparts 522, 526, 528, 530 each of which contains a discrete one of the inline and non-inline attachments of the email in its entirety. The content of each attachment has been severely redacted in the figure due to the length of the base 64 encoded content. The first attachment 522 is the inline .gif baby picture 104a shown in FIG. 1 and named ‘BabyE’. Each pixel of that picture in its entirety is base64 encoded in string 524. The next part 526 contains the 500 Kb attachment the base64 encoded string portion of which is the .gif image entitled ‘BabyG’. The next part contains the 200 Kb attachment 528 the base64 encoded string portion of which is the Microsoft Word .doc file entitled ‘BabyD’. The next part contains attachment 530 contains the 500 Kb attachment the base64 encoded string portion of which is the Adobe Photoshop .psd file entitled ‘BabyP’.

The email client handles the assembly and display of each email including the listing of non-inline attachments and sizes in the ‘Attach:’ field of the Email Clients email GUI. The email client also handles the formatting and display in either HTML or text of the email body including the decoding and display of any inline images.

FIG. 5B shows the received email of FIG. 5A after optimization for delivery to a specific requesting target device, e.g. a mobile communication device such as the cell phone 118 shown in FIG. 1. The delivered email is a single file 550 with header 552, body-text 554 and attachment 560 sections. The header 552 has been cleaned to remove custom headers. The body-text part 554 contains the text and inline image extracted from the original emails (See FIG. 5a) HTML body part. The character encoding 556 has been converted to UTF-8 to ensure compatibility on the receiving device. The attachment section 560 contains the inline attachment 562 and three non-inline attachments 568, 574 and 580.

Attachment 562 is a .jpg image file type 564 named BabyE derived from a conversion of the stored inline attachment 522 (See FIG. 5a) of the same name from a .gif to a .jpg image file type. The .jpg image has been resized, converted and may also be compressed for delivery to the target device. Each of the conversion steps decided on the basis of the hardware and software specifications of the requesting target device and any amendments to same resulting from user preferences. The resultant image file is contained in the base64 encoded string 566.

Attachment 568 is a .jpg image file type 570 named BabyG derived from a conversion of the stored attachment 526 (See FIG. 5a) of the same name from a .gif to a .jpg image file type. The .jpg image has been resized, converted and may also be compressed for delivery to the target device. Each of the conversion steps decided on the basis of the hardware and software specifications of the requesting target device and any amendments to same resulting from user preferences. The resultant image file is contained in the base64 encoded string 572.

Attachment 574 is a .txt text file type 576 named BabyD derived from a conversion of the stored attachment 528 (See FIG. 5a) of the same name from Microsoft WORD .doc document format to a plain text .txt file type. The file type conversion is decided on the basis of the hardware and software specifications of the requesting target device and any amendments to same resulting from user preferences. The resultant text file is contained in the base64 encoded string 578.

Attachment 580 is a .jpg image file type 582 named BabyP derived from a conversion of the stored attachment 530 (See FIG. 5a) of the same name from an Adobe PhotoShop .psd document format to an image file type. The file type conversion is decided on the basis of the hardware and software specifications of the requesting target device and any amendments to same resulting from user preferences. The resultant image file is contained in the base64 encoded string 584.

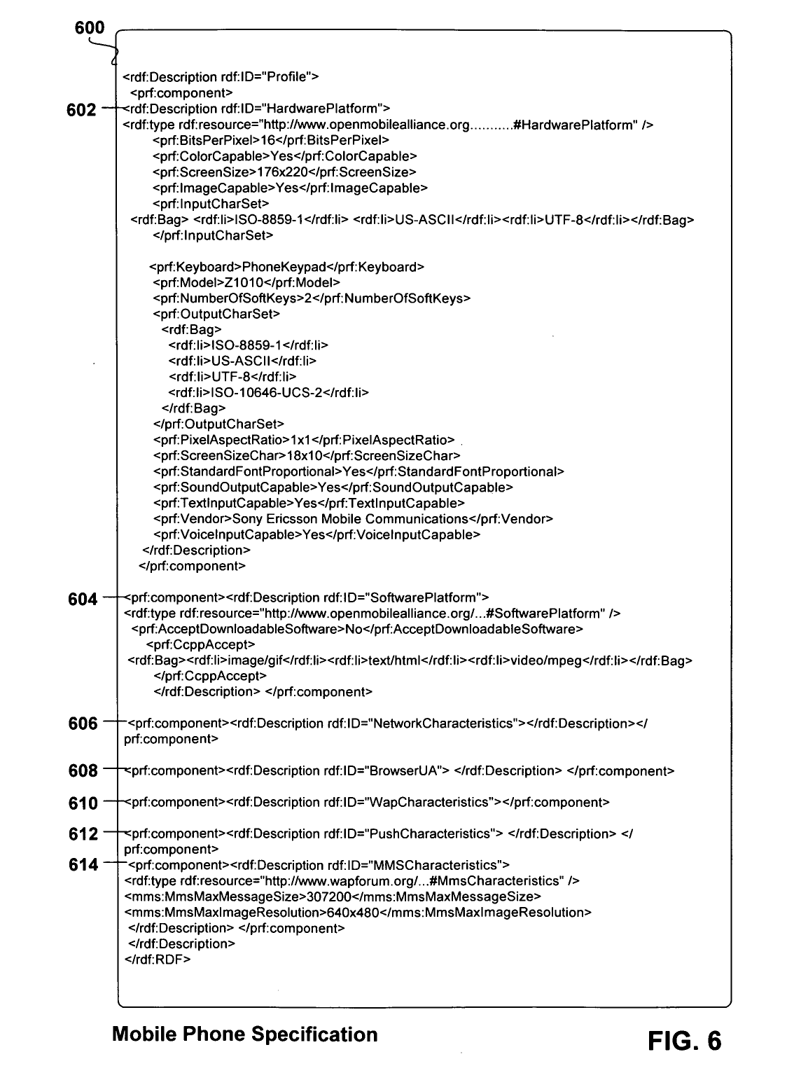

FIG. 6 shows an XML formatted specification 600 for a selected mobile device. In an embodiment of the invention this record obtained from a standard body or the manufacturer themselves is used to form the basis of a device specification record. The device specification record contains a hardware platform section 602, a software platform section 604, a network characteristics section 606, a browser section 608, a wireless access protocol (‘WAP’) section 610, a ‘PUSH’ email characteristics section 612 and a messaging characteristics section 614.

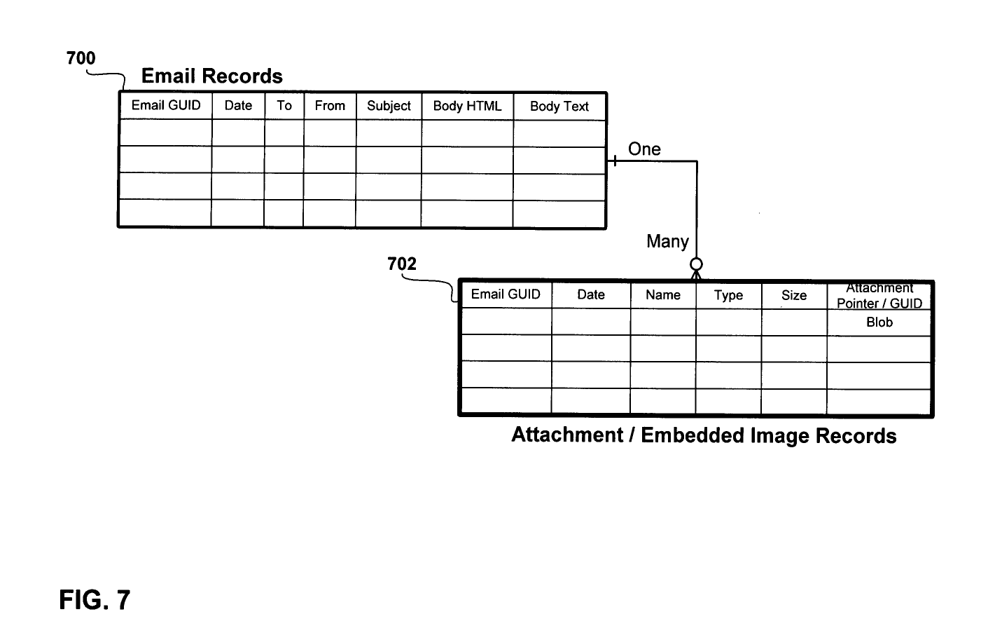

FIG. 7 shows a data structure for discretely managing email header body portions and attachment portions in accordance with an embodiment of the invention. In this embodiment of the invention a first set of records 700 contains the header, body-text and body-HTML porting of a received email. A second set of records 702 is relationally linked to the first set in a many to one relationship. This second set of records 702 contains the actual inline and non-inline attachments associated with a corresponding one of the email header-body records in record set 700. Each attachment record may contain the actual attachment as a ‘blob field’ or pointers to the corresponding attachment stored as a discrete file. In alternate embodiments of the invention the discrete storage of email header-body portions and attachment portions may be achieved by alternate embodiment to the relational table structures shown in FIG. 7, including: object based, flat file based and XML based for example without departing from the scope of the claimed invention.

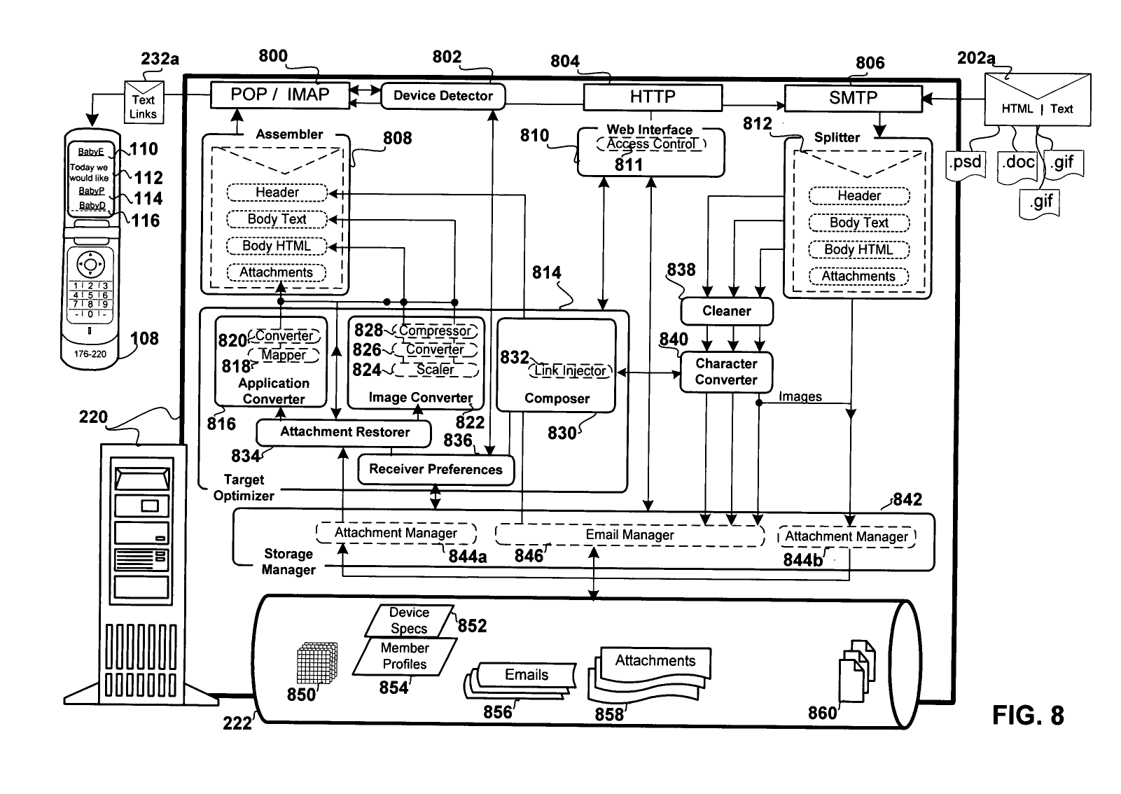

FIG. 8 shows a combined hardware and software block diagram of an embodiment of the email gateway 220 shown in FIG. 2. The email gateway includes modules supporting email and/or attachment transfer via: the Simple Mail Transfer Protocol (‘SMTP’), i.e. SMTP module 806; the Post Office Protocol (‘POP’) and Internet Message Access Protocol (‘IMAP’), i.e. module 800; and the Hypertext Transfer Protocol (‘HTTP’), i.e. module 804. The gateway also includes storage 222 for: program code 850, device hardware and software specification records 852, member profile records 854, email header and body portion records 856, email attachment records 858 and web pages 860.

The email gateway also includes: splitter module 812 for splitting incoming email into header-body and attachment parts; cleaner module 838, character conversion module 840, storage manager 842 for managing records in storage 222, target optimizer module 814 for optimizing delivered emails and/or attachments thereto on the basis of the target device to which they are being delivered, assembler module 808 for assembling the optimized email header-body and attachment portions for delivery, a device detector module for dynamically detecting the make, model and/or specifications of the target device requesting delivery of email, and a web interface module 810 for controlling a users HTTP access to emails and/or attachments.

The email gateway is shown receiving an email 202a (See FIG. 2) via the SMTP module 806. The splitter 812 splits the incoming email into constituent parts including header, body-text, body-HTML, and attachment parts. Each part is then processed in the cleaner module 838 which performs cleanup such as removing: unnecessary tags, prohibited script or attachment types. The character conversion module then converts the character set of the constituent parts to an international standard, typically Unicode, e.g. UTF-8. In an alternate embodiment of the invention this character conversion is performed on a target specific basis upon delivery of an email or attachment. Next the header and body portions of the received email are passed to the email manager sub-module of the storage manager which generates a corresponding email header-body record 856 in storage 222. The attachment portions of the received email are passed to the attachment manager sub-module 844a-b of the storage manager which generates a corresponding attachment record 858 in storage 222.

Delivery of an email and/or attachment invokes target specific optimization. This requires identification of the target device and conversions of the email and/or attachments responsive to the identification.

The target device may be identified based on either or both direct or indirect methods. Direct methods of target communication device detection include: a dynamic detection of the target communication device at time of delivery via the device detector module 802. This dynamic detection may also include an identification of the device capabilities or resident software applications via information contained in a request header.

Indirect methods of target communication device detection also performed by the device detector module 802 include: identifying the email requester via login information, and correlating the requester with an associated member profile record 854 which identifies the recipients target device, and determining there from the corresponding hardware and software specifications of the target device based on an associated one of the device specification records 852 or amendments thereto in the associated member's profile record.

Once the target device is identified the target optimizer affects the appropriate attachment policy based on the capabilities of the requesting, a.k.a. target device and any member preferences applicable thereto. Attachment management determines both the manner of attachment delivery as well as any conversions applicable thereto. Attachments may be: excluded from the email, or included by reference in the form of attachment hyperlinks sorted and labeled by file type, or included in the email. Attachments may also be subject to various types of conversion based on the capabilities of the requesting device. Conversions include: resizing, rotation, compression and changes in file type to correspond with available applications on the target device. The receiver preference sub-module 836 takes the identified hardware and software specifications and recipient preferences for the target device and configures the remaining sub-modules of the target optimizer accordingly. Those sub-modules include: the attachment restorer 834, the application converter 816, the image converter 822, and the composer 830. The storage manager module identifies the emails and/or attachments to deliver. The email header-body portions are passed by the storage manager to the composer 830. The composer handles composing the HTML and Text portions of the email body and interfaces with the character converter 840 if character conversion is required. Additionally, the link injector sub-module 832 of the composer module handles any required injection of attachment hyperlinks into the body of the composed email body. Any required attachments are passed by the storage manager to the attachment restorer sub-module 834 of the target optimizer. The attachment restorer determines if link injection is utilized or not. If delivery of attachments is required then the attachment restorer passes image attachments to the image converter sub-module 822 and other attachments to the application converter sub-module 816.

The image converter handles the scaling of the image to a size corresponding to the display size of the target device in the scaler sub-module 824. Scaling includes: rotation, resizing, and changes of aspect ratio. File type conversions, e.g. from .gif to .jpg file type, are performed by the converter sub-module 826. Any required compression of a lossy image type is performed in the compressor sub-module 828, again on a device specific basis as specified in hardware and software specifications for the target device and any amendments thereto resulting from the member preferences.

The application converter handles any required conversion of the file type of the attachment to a file type supported by an application resident on the target device as indicated by either the software specifications for the target communication device to which the attachment will be delivered and/or by member preferences amending same. The mapper sub-module 818 determines which conversion to perform and a selected one of the converter sub-modules 820 performs the required conversion, e.g. Adobe Photoshop .psd file type to .jpg image type. Conversion of an Adobe Photoshop file type in this instance may involve analyzing image and text layers of the .psd file to determine a composite view from which composite view a graphical image file is generated in .jpg format. The converted attachment may also be subject to subsequent conversion by the image converter, e.g. scaling and compression, if required.

Next, the various converted attachments and email header and body portions are delivered from the target optimizer to the assembler 808 for assembly into one or more emails the delivery of which to the requesting email client of the target device is affected by the POP/IMAP protocol module 800. In FIG. 8, the email gateway 220 is shown delivering an email 232a to an email client via the POP and IMAP module 800. This module either singly in combination with the SMTP module 806 supports retrieval of email from the email gateway via an email client on either a Pull or Push basis.

Where target specifications or member preference amendments thereto avoid delivery of attachments with emails, those attachments remain accessible either via selection of attachment hyperlinks in the associated delivered emails or directly via one or more web pages 860 specifically provided to members for the purpose. An exemplary web page 400 for direct query and delivery of attachments is shown in FIG. 4. The HTTP module 804 provides such access via the web interface module 810 and the access control sub-module 811 thereof.

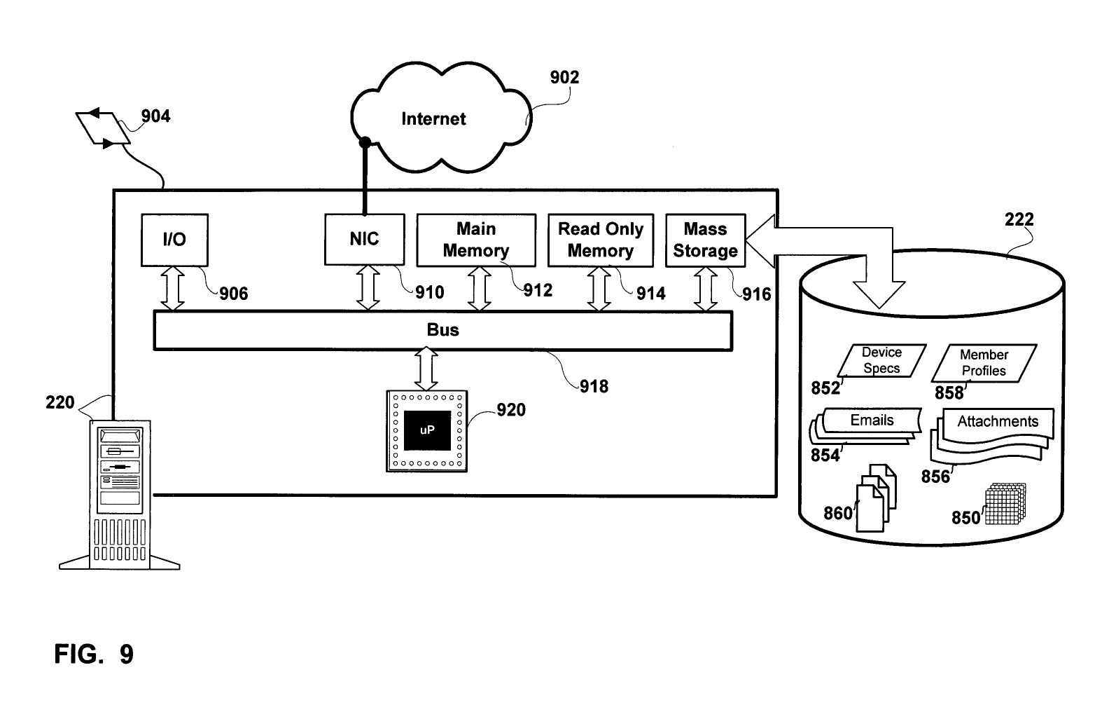

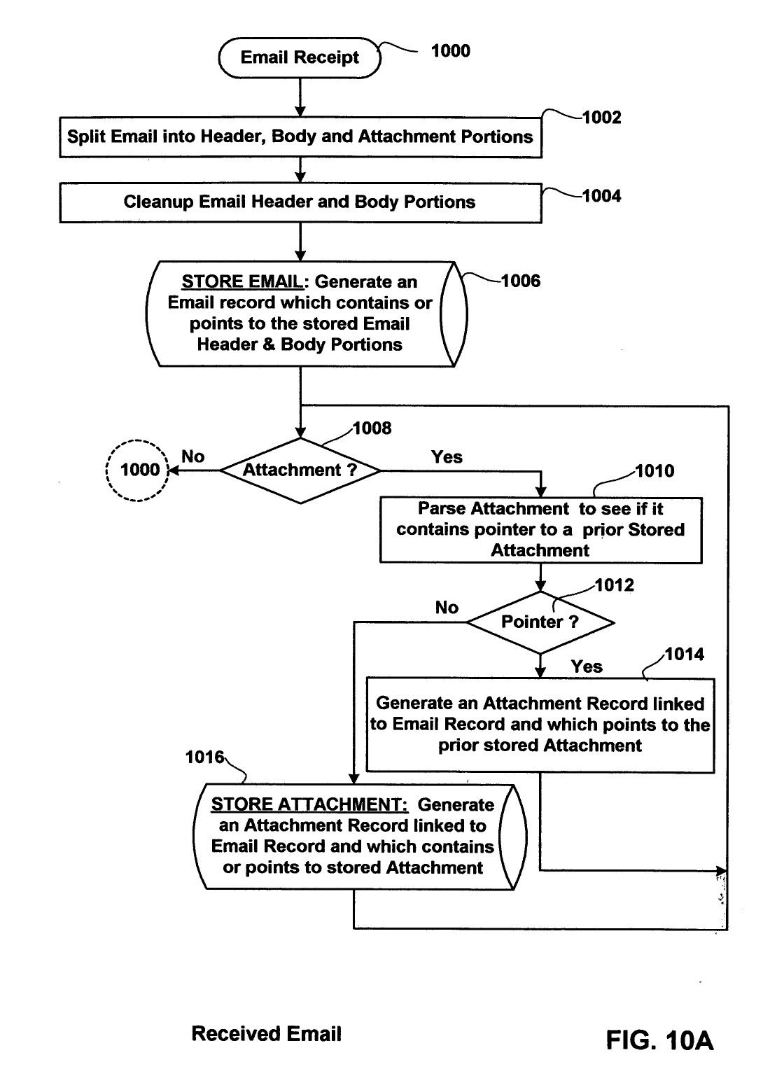

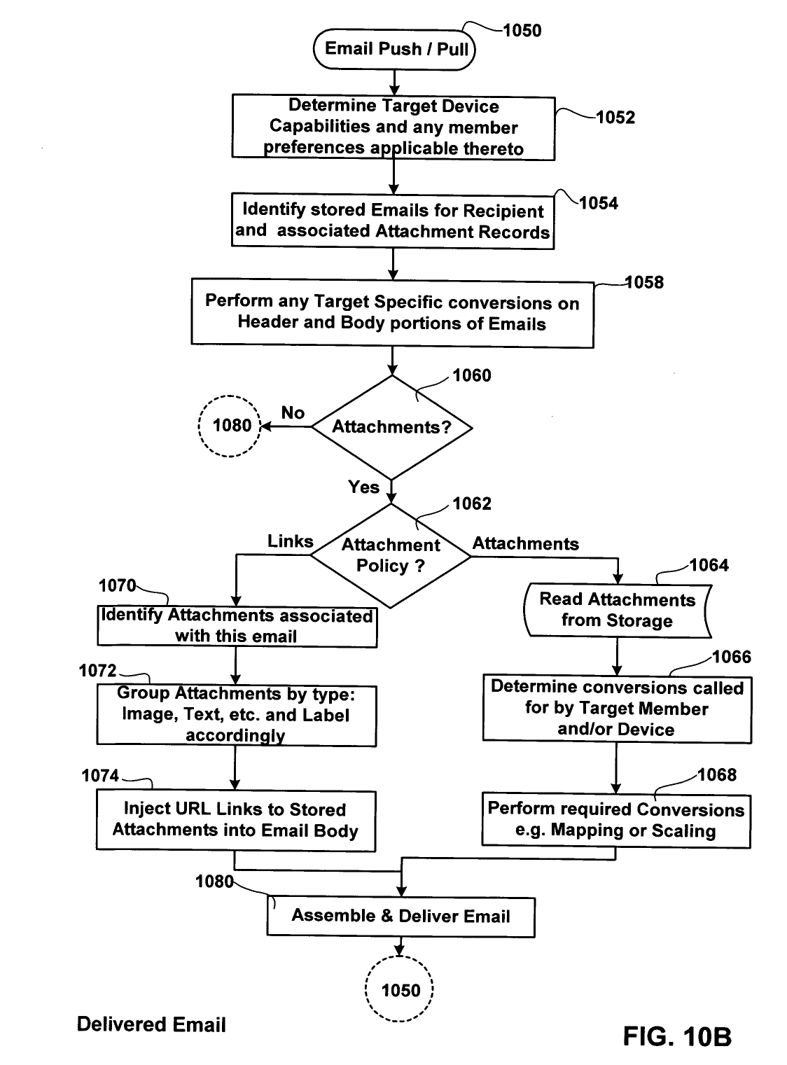

FIG. 9 shows a hardware block diagram of an embodiment of the email gateway shown in FIG. 2. The gateway includes an local bus 918 to which input-output component 906, network interface component (NIC) 910, main memory component 912, read only memory component 914, mass storage component 916, and processor 920 couple. The input output module handles direct access to the gateway via keyboard and screen interfaces for example by for example an administrator of the gateway. The NIC handles the interface of the gateway with the Internet 902 or other local or wide area wireless or wired networks. The main memory handles the volatile storage of program code, calculations performed thereon, and the caching of intermediate data required thereby during the operation of the gateway. The read only memory 914 stores the Basic Input Output System (BIOS) and other program code generic to the operation of the computer. The mass storage component 916 handles the interface with the media utilized for storage 222. The processor 920 executes the stored program code 850 to effect the processes 904 shown in the following FIGS. 10A-B and 11.

FIGS. 10A-10B show process flow diagrams for email receipt and delivery in the email gateway of FIG. 2, in accordance with an embodiment of the invention. Processing of an incoming email begins at step 1000 in which email delivery via SMTP or other required protocol is affected. Control the passes to process 1002 in which the received email is split into header body-text, body-HTML, and attachment portions. Then cleanup of the email header and body portions is affected in process 1004. Next in process 1006 the email header-body portions are stored and associated email record added to storage. In decision process 1008 a determination is then made if any inline or non-inline attachments are included in the received email. If not control returns to process 1000. If attachments are included in the email control passes to process 1010. In an embodiment of the invention process 1010 handles the determination of whether or not the received attachment corresponds to a previously received attachment which is currently located in storage. This would be the case for example in an email forward of a previously received and subsequently delivered email handled by the gateway. In an embodiment of the invention this determination is made on the basis of a unique attachment identifier embedded in the attachment itself by the gateway during the delivery process. If such an identifier or pointer exists then in decision process 1012 an affirmative decision is reached as to the presence of the pointer and control is passed to process 1014. In process 1014 an attachment record is generated which contains or points to the prior stored attachment and the attachment record is linked to the email record generated in process 1006. Control then returns to decision process 1008 for processing the next attachment. Alternatively, if in decision process 1012 no identifier or pointer to a prior stored attachment is found then control passes to process 1016. In process 1016 the received attachment is stored in or with the associated attachment record. The attachment record is linked to the email record generated in process 1006. Control then returns to decision process 1008 for processing the next attachment.

FIG. 10B shows the processes associated with delivery of a email optimized on a target specific basis for the communication device to which the delivery will be affected. Email delivery begins in process 1050 with the email request ‘Pull’ from the target device, or notification ‘Push’ from the gateway to the target device is affected.

In process 1052 the capabilities, e.g. hardware and software, of the requesting or target device are determined along with any member preferences applicable thereto. The target device capabilities may be identified based on either or both direct or indirect methods. In an embodiment of the invention this determination may be made dynamically based on information in a request header from the requesting or target device. In another embodiment of the invention this determination may be made on the basis of device specification records for the specific target device and or any member profile records applicable to the requesting device.

Next, in process 1054 all stored emails for the recipient or the subset of stored emails requested by the recipient is identified along with the associated inline and non-inline attachment records. Then in process 1058 any required conversions are performed on the header and body portions of the emails to be delivered.

Then in decision process 1060 a determination is made as to whether there are any attachments associated with the email to be delivered. If not control passes directly to process 1080 for the assembly and delivery of the email. If attachments are associated with the specific email to be delivered then control passes to decision process 1062.

Next in decision process 1062 a determination is made based on member preferences and/or target device specifications whether to include attachments with the delivered email. If attachments are to be included control passes to process 1064. If they are not to be includes then control passes to process 1070. In process 1064 attachments are copied from storage. Then in process 1066 the conversions called for by target device specifications and/or member preferences amendments thereof are determined and in process 1068 performed after which control passes to process 1080 for assembly and delivery of the email including converted attachments. Alternately, if no attachments are to be included, any attachments associated with the delivered email are determined in process 1070. Then in process 1072 the attachments are grouped by type, e.g. picture or document and Uniform Resource Locator (URL) URL hyper links are generated for each. The hyperlinks are sorted by attachment type and labeled accordingly. Then in process 1074 the hyperlinks are injected into the email body. Control then passes to process 1080 for assembly of the email.

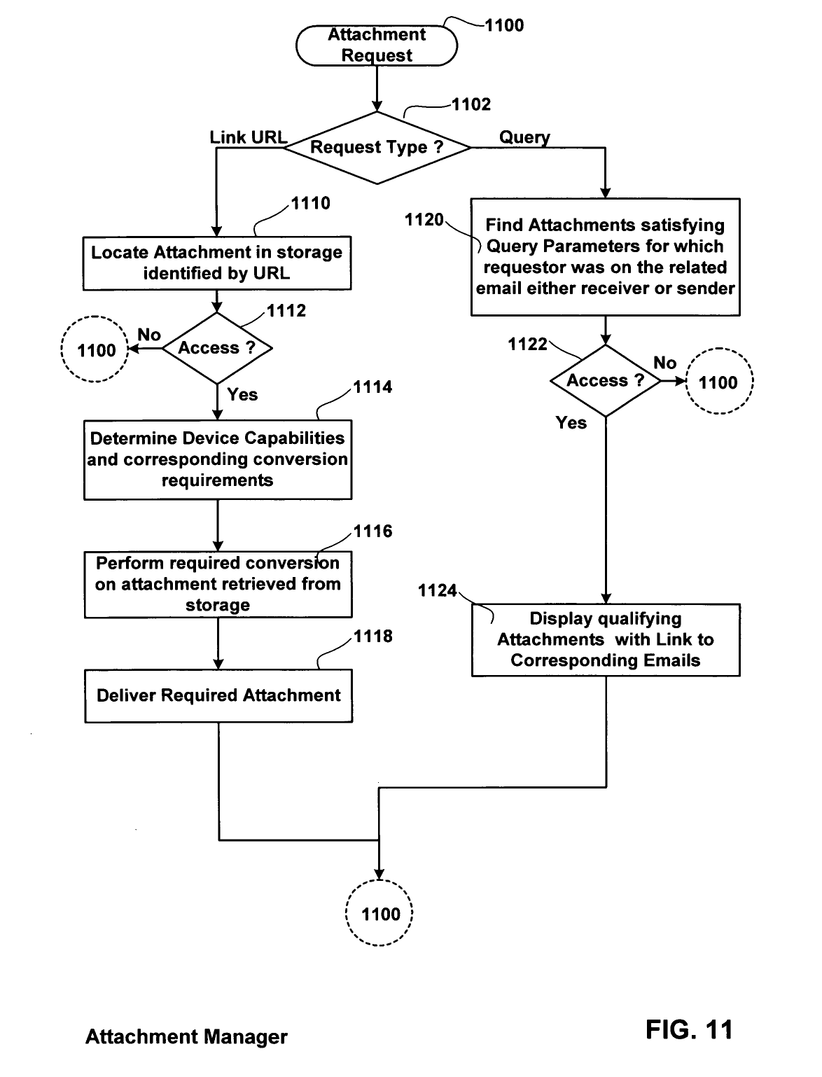

FIG. 11 is a process flow diagram of processes associated with managing discrete attachment requests or queries in the email gateway 220 of FIG. 2, in accordance with an embodiment of the invention. The processing begins in process 1100 with a direct or indirect attachment request. If the attachment request has the form of an URL link to the attachment then a corresponding determination in decision process 1102 passes control to process 1110. Alternately, if an attachment query is received via one or more of the attachment web pages (See FIG. 4, page 400) provided to members with accounts on the gateway then control is passed to process 1120.

Processing of attachments selected via hyperlinks embedded in delivered emails commences in process 1110 in which the attachment is located in storage and subject for security purposes to access control processing in decision process 1112. This access control processing limits users who can retrieve an attachment to those users to which the embedded links was delivered, i.e. those listed in the From, To, CC, or BCC fields of the email and may require login or IP address identification to do so. In an embodiment of the invention member preferences for attachments may also be taken into account in determining access rights. An example of the setting of these member preferences is shown and described in FIG. 4 and the attachment management web page shown therein. In the attachment manager portion thereof, and specifically portion 404 the sender can set recipient privileges for received attachments including: viewing, downloading and editing thereof. If access to the attachment is not appropriate then control returns to process 1100 and if appropriate to process 1114. In process 1114 the conversion requirements for the attachment are determined based on device capabilities of the device to which the attachment will be delivered along with any amendments to same resulting from member preferences. Then in process 1116 any required conversion is performed on the attachment retrieved from storage. Next, in process 1118 the attachment is delivered to the target device on which the URL link was selected after which control returns to process 1100.

If alternately, the attachment request is a query type, e.g. via attachment management web page 400 and specifically the attachment search form 410 portion thereof as shown in FIG. 4, then control passes to process 1120. In process 1120 attachments for which the member generating the query was a recipient or mailer and which satisfy the query are identified. Then in decision process 1122 the attachments located in process 120 are additionally filtered to reflect any additional access control considerations arising from member preferences established by the attachment sender in the attachment sent portion 404 of the attachment management web page shown in FIG. 4. Any attachments for which access remains appropriate are in process 1124 displayed along with links to corresponding emails. (See FIG. 4, search result list portion 412). A selection of an email link on any given attachments row record results in a popup window which displays the associated email's body portion. Control then returns to process 1100.

The foregoing description of a preferred embodiment of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. An email gateway configured to couple to at least one network of communication devices, and the email gateway comprising:
a splitter to split received emails into discrete body and attachment portions;
a database coupled to the splitter and configured to store the discrete body and attachment portions of each email received from the splitter;
a device detector to detect hardware and software capabilities of a communication device prior to delivery of email to same; and
a target optimizer coupled to the database and the device detector and responsive to an email request to optimize the body and attachment portions of associated emails for delivery to the communication device based on the capabilities of the communication device as detected by the device detector.

2. The email gateway of claim 1, further comprising:
the target optimizer further responsive to the email request, to inject into the body portion of each associated email selectable URL links for retrieving associated attachments over the network and the target optimizer further responsive to receipt of an attachment request based on a selection of an URL link to convert the corresponding attachment retrieve the database to a file type which conforms with the capabilities of the target device.

3. The email gateway of claim 1, further comprising:
the target optimizer further responsive to the email request, to convert associated attachment portions of each email from a non-supported file type to a supported file type for the targeted device based on the capabilities of the communication device detected by the device detector.

4. The email gateway of claim 1, further comprising:
the target optimizer further responsive to the email request, to resize associated image attachment portions to conform to a display size of the targeted device detected by the device detector.

5. The email gateway of claim 1, further comprising:
the target optimizer further responsive to the email request, to rotate associated image attachment portions to conform to a display size of the targeted device detected by the device detector.

6. The email gateway of claim 1, further comprising:
a character code converter to convert received email from a regional character code to an international character code.

7. The email gateway of claim 1, further comprising:
at least one member preference web page for entering member preferences for conversion of delivered email attachments; and
the target optimizer responsive to a request to deliver received emails to the communication device to manage the conversion of the attachment portions of each email based on the member preferences entered via the at least one member preference web page.

8. The email gateway of claim 1, further comprising:
at least one member preference web page for entering member preferences for storage of email attachments; and
a storage manager coupled to the database and responsive to receipt of the attachment portions of received email to manage attachment storage policy based on the member preferences entered via the at least one member preference web page.

9. An email gateway configured to couple to at least one network of communication devices, and the email gateway comprising:
a splitter to split a received email into discrete body and attachment portions;
a database coupled to the splitter and configured to store the discrete body and attachment portions of each email received from the splitter;
at least one attachment management web page for searching and viewing email attachments independently of emails associated therewith;
a storage manager coupled to the database and responsive to a query entered by an email recipient via the at least one attachment management web page to retrieve from the database attachments emailed to the recipient which match the recipient's query parameters for display on the at least one attachment management web page.

10. A method for an email gateway configured to couple to at least one network of communication devices, and the method comprising:
splitting received emails into discrete body and attachment portions;
storing the discrete body and attachment portions of each email split in the splitting act;
determining hardware and software capabilities of a communication device prior to delivering email to same; and
converting associated email attachments stored in the storing act to formats supported by the communication device as determined in the determining act;
whereby email attachments delivered to the communication device conform to the device capabilities.

11. The method of claim 10, wherein the converting act further comprises:
injecting into the body portion of each delivered email selectable URL links for retrieving associated attachments over the network; and
converting an attachment requested by a communication device via a selectable URL link to a format which conforms with the capabilities of the requesting communication device as determined in the determining act.

12. The method of claim 10, wherein the converting act further comprises:
converting associated attachment portions from a non-supported file type to a supported file type for the communication device based on the available software applications and supported file types of the communication device as determined in the determining act.

13. The method of claim 10, wherein the converting act further comprises:
resizing associated image attachment portions to a size which conforms to the display size of the communication device as determined in the determining act.

14. The method of claim 10, wherein the converting act further comprises:
rotating associated image attachment portions to conform to the display size of the communication device as determined in the determining act.

15. The method of claim 10, further comprising:
converting received email from a regional character code to an international character code.

16. The method of claim 10, further comprising:
providing at least one member preference web page for entering member preferences for conversion of delivered email attachments; and
converting the attachment portions of each email based on the member preferences entered via the at least one member preference web page provided in the providing act.

17. The method of claim 10, further comprising:
providing at least one member preference web page for entering member preferences for storage of email attachments; and
managing storage of the attachment portion of each received email based on the member preferences entered via the at least one member preference web page provided in the providing act.

18. A method for an email gateway configured to couple to at least one network of communication devices, and the method comprising:
splitting received emails into discrete body and attachment portions;
storing the discrete body and attachment portions of each email split in the splitting act;
providing at least one attachment management web page for searching and viewing email attachments independently of emails associated therewith;
retrieving from the database attachments emailed to the recipient which match the recipient's query parameters responsive to a query entered by an email recipient via the at least one attachment management web page provided in the providing act.

19. Computer software, tangibly embodied in a computer-readable medium or a propagated carrier signal, for an email gateway configured for use over at least one network of communication devices; and the software comprising instructions to perform the following operations:
splitting received emails into discrete body and attachment portions;
storing the discrete body and attachment portions of each email split in the splitting act;
determining hardware and software capabilities of a communication device prior to delivering email to same; and
converting associated email attachments stored in the storing act to formats supported by the communication device as determined in the determining act;
whereby email attachments delivered to the communication device conform to the device capabilities.

20. The software of claim 19, in which the instructions further comprise instructions for:
injecting into the body portion of each delivered email selectable URL links for retrieving associated attachments over the network; and
converting an attachment requested by a communication device via a selectable URL link to a format which conforms with the capabilities of the requesting communication device as determined in the determining act.

21. The software of claim 19, in which the instructions further comprise instructions for:
converting associated attachment portions from a non-supported file type to a supported file type for the communication device based on the available software applications and supported file types of the communication device as determined in the determining act.

22. The software of claim 19, in which the instructions further comprise instructions for:
resizing associated image attachment portions to a size which conforms to the display size of the communication device as determined in the determining act.

23. The software of claim 19, in which the instructions further comprise instructions for:
rotating associated image attachment portions to conform to the display size of the communication device as determined in the determining act.

24. The software of claim 19, in which the instructions further comprise instructions for:
converting received email from a regional character code to an international character code.

25. The software of claim 19, in which the instructions further comprise instructions for:
providing at least one member preference web page for entering member preferences for conversion of delivered email attachments; and
converting the attachment portions of each email based on the member preferences entered via the at least one member preference web page provided in the providing act.

26. The software of claim 19, in which the instructions further comprise instructions for:
providing at least one member preference web page for entering member preferences for storage of email attachments; and
managing storage of the attachment portion of each received email based on the member preferences entered via the at least one member preference web page provided in the providing act.

27. Computer software, tangibly embodied in a computer-readable medium or a propagated carrier signal, for an email gateway configured for use over at least one network of communication devices; and the software comprising instructions to perform the following operations:
splitting received emails into discrete body and attachment portions;
storing the discrete body and attachment portions of each email split in the splitting act;
providing at least one attachment management web page for searching and viewing email attachments independently of emails associated therewith;
retrieving from the database attachments emailed to the recipient which match the recipient's query parameters responsive to a query entered by an email recipient via the at least one attachment management web page provided in the providing act.
